(19) United States
(12) Patent Application Publication
(10) Pub. No.: US 2005/0187809 A1
(43) Pub. Date: Aug. 25, 2005

(54) Adaptive process systems and methods for managing business processes

(76) Inventor: Brian C. Falkenhainer, Danville, CA (US)

Correspondence Address: MORRISON & FOERSTER LLP, 755 PAGE MILL RD, PALO ALTO, CA, 94304-1018, US

(21) Appl. No.: 11/035,697

(22) Filed: Jan. 13, 2005

Related U.S. Application Data
(60) Provisional application No. 60/536,299, filed on Jan. 15, 2004.

(51) Int. Cl. G06F 17/60

(52) U.S. Cl. 705/9

(57) ABSTRACT

A system and associated method which are computer enabled provide automation, management and user decision support of long-running, distributed business processes whose flow is variable and partially determined by user decisions. The system dynamically schedules and assigns tasks in response to current process data and provides context-sensitive support for required user decisions. Each process instance is represented by a set of activities, a set of participants, and a set of constraint relationships between them that as a whole specify the implications of current process data, the current process state, and the current and future process options. The system is open, enabling users to extend the process instance with unstructured activities. Where tasks are assigned to other software applications and the required actions are fully determined, the system will automatically make the required requests and ensure task completion. An electronic audit trails maintains a record of all actions, providing the basis for ongoing performance analysis. The system and method can be applied to any business or similar process having one or more users and software systems across one or more locations and computer networks.

### CROSS-REFERENCE TO RELATED APPLICATION

This application claims priority to U.S. Provisional Application No. 60/536,299 filed Jan. 15, 2004, incorporated by reference herein in its entirety.

### COPYRIGHT NOTICE

This document contains material subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to the field of computers, telecommunications, and computer and Internet related systems. More specifically the invention relates to software systems and processes generally used in the execution of business and other organizational processes.

### BACKGROUND

A business process is e.g. a sequence of activities whose ultimate objective is to produce a product or provide a service. Each activity in the sequence involves physical, intellectual or computational items of work that are intended to bring the business closer to the objective, though that need not be their actual effect and their relationship to the objective need not be known nor otherwise made explicit. In this context, relevant business processes are at least in part computer enabled. Activities may be strictly ordered with respect to one another, conditionally ordered or completely unordered; they may be performed during overlapping intervals of time (“parallel”) or during disjoint intervals of time (“sequential”); they may be automated, partially automated or performed manually; they may be predefined or spontaneously invented; and they may be performed using resources within or outside the business.

It is known to create a normative representation, called a “process specification”, of each business process class to establish guidelines, enable analysis, or set software requirements. It is also known to distinguish each class member, called a “process instance”, that denotes an actual activity sequence that is occurring or has occurred. A long-standing challenge is that the process specification may not accurately represent all process instances within the class.

For all businesses, there is a critical need to optimize business processes to achieve the best possible business performance. The maturing discipline of business process reengineering, coupled with computer software to enable the newly reengineered processes, led to unprecedented productivity and quality gains during the 1990s. The greatest gains were achieved in industries that were most able to adopt software to automate and manage business processes, and to assist personnel in complex intellectual tasks.

There are known various techniques for automating and managing business processes between multiple users, typically called “workflow”, between multiple computer software applications, typically called “application integration”, and between a plurality of users and software applications, typically called “business process management”. Common to these systems is the representation of a process specification as a deterministic sequence of “states”, wherein each state denotes an interval of time defined by a fixed set of data values and activities. The predominant technique for defining, assigning and managing these state sequences, an example of which is Oak Grove Systems™ Reactor™ software, provides the concept of “state machines”. A state machine represents a business process as an explicit, finite and predetermined set of states and transitions between the states. These transitions may be conditionalized such that state “A” transitions to state “B” under one set of conditions, while state “A” transitions to state “C” under a different set of conditions. When a relevant data value is changed or an activity is completed, the appropriate transition is taken to arrive at the next state.

A variant on the state machine concept is the “rules-based” technique, which represents a process as a set of decision rules. Process states, or subsets of states, are encoded in each rule, with the rule preconditions denoting a “from” state and the rule post-conditions denoting a “to” state. The rules based technique is a representation variant that is functionally equivalent to state machines but requires a different run-time embodiment that has different development time and cost characteristics.

These techniques have proven to work well for business operations whose processes are fixed enough to be accurately prescribed by a deterministic sequence of predefined states and simple enough to enable development of the process specification with reasonable time and cost. Examples include circulation of documents for review, the flow of parts in standardized supply chains, and the flow of transactions between multiple databases. However, for a large class of business operations, particularly those requiring skilled judgment, these techniques have either failed to achieve market acceptance or have failed to produce substantive return on investment. The root cause is these techniques' inability to adequately support the fluid, judgment-driven nature of the business. Exemplary technical limitations are:
1. The process specification is predefined and fixed. Only those states, those state inputs and outputs, and those transitions between states that were explicitly specified are allowed, even if more optimal paths are possible or business conditions require alternate states and transitions. For business processes of moderate complexity, it is very difficult, if not impossible, to anticipate all possible conditions in advance. New conditions are discovered during the course of business, while business conditions, market tactics, and policies change over time. The need for software developers to continually update the static process specification creates high maintenance costs and limits the business' ability to adapt to change.
2. The process specification is treated as being complete. All desired states and transitions must be anticipated and explicitly specified by the process specification developer. For business processes of moderate complexity, a complete process specification quickly becomes unmanageable.
3. When exceptions to the process arise, most systems stop and wait for one or more users to determine the proper course of action. Some systems include the ability to specify transition to an “exception” state, but the result is the same. During the exception condition, the system is unable to assist users and unable to track their activity. Typically, a significant amount of manual work is required to develop a response that conforms to the predefined process.
4. The process is represented and treated as a linear sequence of atomic steps. There is no ability to represent and manage options, including as-yet unknown options. In many business processes, the identification and consideration of options is a primary part of the effort, yet it is left unaddressed in the prior art.
5. Process management techniques assign, route and track the status of named activities. There is no representation or maintenance of the dependencies, assumptions, inputs, conclusions or implications of the decisions being made throughout the process, which limits analysis, fault recovery, and the assistance that can be offered users.
6. There are no integrated techniques to assist users in their assigned work. For complex intellectual tasks, the majority of the effort that impacts business performance is therefore unaddressed.

There are known various computer based techniques for assisting personnel in complex intellectual tasks, typically called “decision support systems”. These systems use logical or mathematical models of a problem domain, such as forecasting investment markets or insurance risks, to recommend decisions and/or predict future behavior from a set of input data. Decision support systems are designed, developed, marketed and used separate and distinct from process management systems. They are used to produce a specific task result, either in response to a single input or stochastically to form a probabilistic estimate.

For many business processes, the decision making effort required to complete individual activities is intimately tied to the decision making effort required to determine which activities to perform and in what order. The separation between decision support and process management systems limits the benefits they could potentially offer and increases system development time and cost. Functions lacking include:
1. The immediate and fine-grained ability to change process activities in direct response to individual decisions.
2. The ability to use potential process impacts as part of an activity's decision criteria, such as the implications of different assumptions and decisions on process time, cost, resource utilization, or subjective desirability.
3. The ability to have decision support offered that is sensitive to and specialized for the current process context.
4. The ability to utilize one representation of the business operation for both decision support and process management, thereby reducing the time and cost of system development and maintenance.

Thus the present inventor has determined there exists a need for process management techniques, and integrated process management and decision support techniques, that overcome the above practical drawbacks.

### SUMMARY

According to the present invention, a computer based process management system has associated data defining business operation constraints, and a plurality of process participants. A participant may be a user (person) or a software application (program). Each participant is operatively coupled to or uses a computer that is in turn connected to the process management system via a conventional communications network such as a LAN, the Internet or a wireless network. The process management system (software executing on a computer) maintains a constraint network including activity definitions, activity role specifications, participant definitions, data related to the current process instance, and constraints defining logical and mathematical relationships between them. As data values change in response to participant input or time-dependent events, the process management system modifies the constraint network to reflect the logical and mathematical implications of those changes. Using the constraint network, the process management system dynamically identifies and schedules the optimal set of activities to perform in accordance with the operational constraints of the business. Where activities cannot be fully determined but a set of valid options exist, an activity to decide among the set of options is assigned to one or more users, along with the relevant constraint dependencies. The user may inspect the options, dependencies and consequences of selecting each option. The set of options may be declared to be open, thus allowing participants to form previously unrepresented activities, subject to this right being granted to the participant. A role resolution handler maps the activities' role specifications to current or new participants and assigns the activities to those participants. The process management system tracks all assigned activities, receiving data from and sending updates to their assignees. An electronic log (audit trail) maintains a record of all actions, providing the basis for ongoing performance analysis.

The relevant processes to be managed are not confined to businesses per se but extend to other entities and organizations (government, non-profit, etc.) as well.

Also provided are associated process management methods and software, e.g. in the form of computer code stored or embodied in a computer readable storage medium such as a CD, computer memory, etc.

According to another aspect of the present invention, there are a plurality of associated process management systems, each of which is provided with synchronization techniques and connected to the others via a network. Each participant is operatively coupled to a computer that is in turn connected to one or more of the process management systems via a network. A process begins at one system, which is said to be participating in the process. As implied by the constraint network or the resolution handler, additional systems may be joined to the process. Each system maintains an associated constraint network that may include all or a portion of the process representation. When changes occur within a system's constraint network, those changes are communicated to the other participating systems such that they collectively maintain a complete and consistent process representation.

An advantage is the provision of an overall process management system that establishes strong guidelines and control for business environments that require sophisticated decisions with fluid response.

Another advantage is the provision of a process management system that automatically supports complex intellectual tasks in a manner that is context-sensitive, both with respect to the task at hand and with respect to its role within the larger process.

Yet another advantage is the provision of a process management system that can be quickly deployed at low cost with a partial specification of the business guidelines. This advantage is furthered by the system's process record, which can be used on an empirical basis to quantitatively assess current processes and guide future revisions.

Details of one or more embodiments are set forth in the accompanying drawings and the description below. Further features and advantages will become apparent to one of ordinary skill in the art from the claims, description and drawings.

### BRIEF DESCRIPTION OF THE DRAWINGS

FIG. 1 is a block diagram of a single process management system implemented in the environment of a network of computers associated with a plurality of participants.

FIG. 2 is a block diagram showing the environment of FIG. 1 configured with a plurality of process management systems. Participants of a process instance may be connected to one or more of the process management systems involved in managing that process instance.

FIG. 3 is a block diagram showing the components and their interactions of an exemplary process management system in accordance with the present invention.

FIG. 4 is a process specification for an example of the business process obtaining an insurance policy quote.

FIG. 5 is an illustration of the data created and managed for an instance derived from the process specification shown in FIG. 4.

FIG. 6 is a more detailed illustration of a portion of the constraint network in FIG. 5, for the case in which the insurance policy applicant has ten prior insurance claims and the property to be insured is located in California and worth $1,100,000.

FIG. 7 is a more detailed illustration of a portion of the constraint network in FIG. 5 that has been reformulated to use “closed world” assumptions.

FIG. 8 is an illustration of a document requirements table.

### DETAILED DESCRIPTION

Terms

A user of a process instance is a person who has accessed the process or who is explicitly represented and identified as having a role in the process, even if they have not accessed it.

A resource is a software application, data source or electronically-controlled device that is accessible to the system. Examples include databases, applications, web pages, files, scanners and printers.

A participant of a process instance is any user or resource of that process instance.

An activity is a unit of work within a process instance. Each activity is assigned to zero or more participants. An activity may equate to application data retrieval and processing, a decision, or a long-running effort carried out by a set of users. The inputs, outputs, duration and actions of an activity may be fully specified in detail, fully unspecified, or partially specified. An activity may be a named composition of activities.

A constraint is a mathematical or logical relationship between one or more participants, activities and resource data values. A constraint only exists as an element of a process instance. Potential mathematical relationships include, but are not limited to, equations, inequalities and set arithmetic. Examples of a constraint relationship include the temporal precedence between activities, conditions for when an activity is or is not required, and limits on one set of data values as a function of other data values.

An adaptive process (AP) instance is the set of participants, data, constraints and events managed by the process management system, and its associated operations on them, for a single business process instance. An AP instance only exists at software execution time, not at software development time.

A role is a named placeholder for a set of participants that may or may not be identified.

Role resolution is the act of assigning (binding) identified participants to a role. A resolution handler as illustrated below is software that performs role resolution based on particular criteria, such as balancing assignments evenly across a named set of users.

An activity definition is a universally quantified, declarative specification of a named activity class. It defines all known inputs, outputs, functions, and roles for activities within the class. It can also define constraints for when the activity definition applies, and constraints between any subactivities of which it may be composed. In some applications, it may be useful to further distinguish an activity definition as being eligible to start a new AP instance and in this context it may informally be called a process, as in “a request to start the xyz process”.

A constraint definition is a universally quantified, declarative specification of a constraint class. Syntactically, a constraint definition may appear independently, as part of an activity definition, or within any application-specific convention.

A process specification is the set of activity and constraint definitions that are registered with the process management system and used to manage all AP instances.

These and other term explanations herein are not limiting, but only illustrative.

System Overview

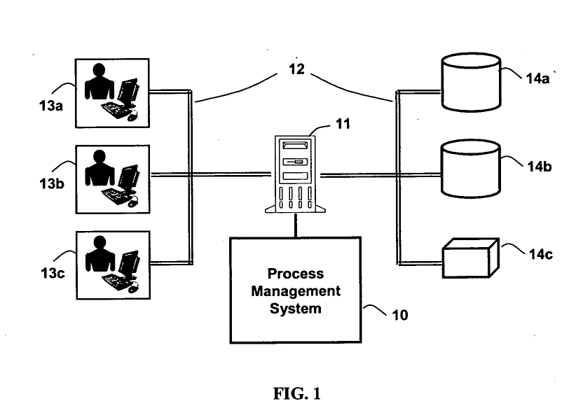

FIG. 1 is a block diagram showing main elements of the process management system's environment according to the present invention. A process management system 10 here is software being executed on a conventional, e.g. desktop, or other computer 11 which is connected to or accessible by one or more computer users 13a-13c and none or more resources 14a-14c via a conventional computer network 12 for the purpose of managing process instances of which the users and resources are participants. The network 12 may be any one by which the participants and the process management system can communicate, including a combination of local area networks, the Internet, or wireless networks. Users 13a-13c may use any networked computing device, including a desktop or other computer 11, PDA or pager, as well as any combination thereof to communicate with the process management system 10.

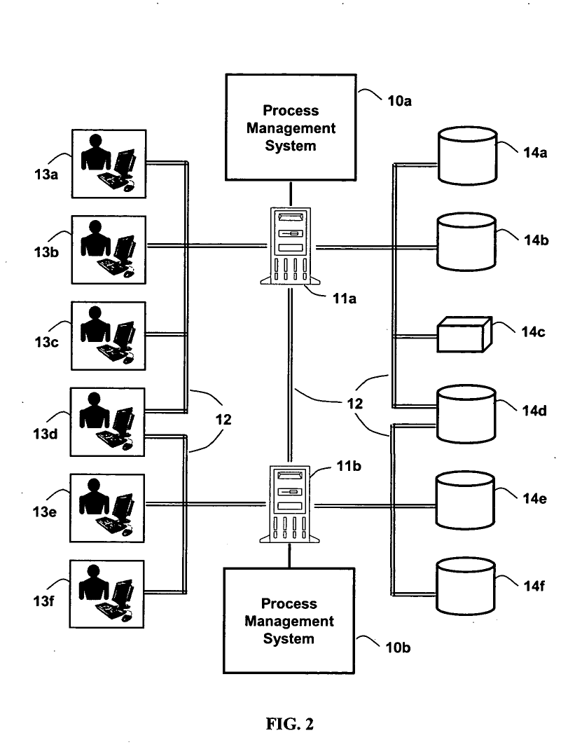

FIG. 2 shows the same elements configured with a plurality of process management systems 10a, 10b. In this configuration, participants 13a-13f and resources 14a-14f may interact with one or more process management systems 10a, 10b during the course of a process instance. The process management systems 10a, 10b communicate with each other to maintain global consistency and properly manage the overall process instance.

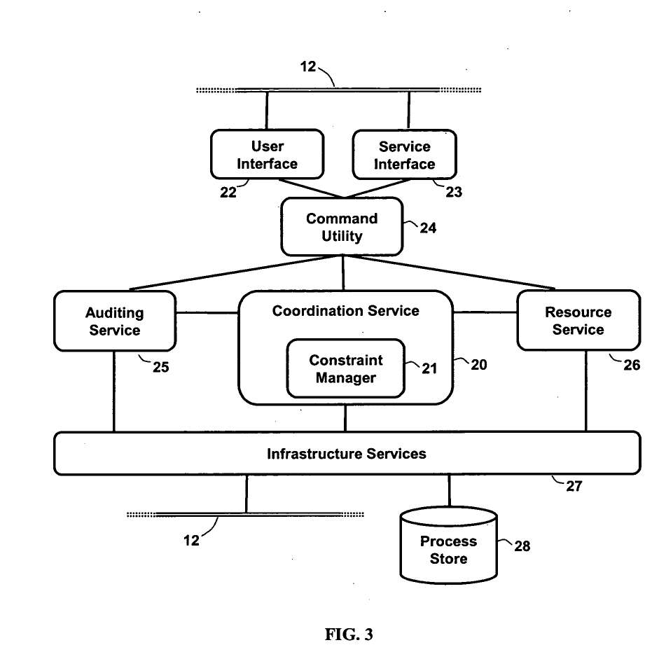

An exemplary embodiment is Resonant Software's commercially available process management system, called the “Adaptive Process (AP) Hub”, whose relevant components are depicted in FIG. 3. Users and client applications interact with the AP Hub over network 12 through interfaces 22 and 23, respectively, which forward their requests to command utility 24. Coordination service 20 manages all process instances, with a constraint manager 21 used to maintain the status of relationships between participants, activities, resource data, and the implications of those relationships. An auditing service 25 records and reports on all process instance events; it is responsible for the process record. A resource service 26 provides utilities to handle the AP Hub's interactions with resources. Infrastructure services 27 support the AP Hub's interactions with the surrounding networked infrastructure, communicating with such external services as directories, authentication, messaging, event management, and persistent storage mechanisms. Embodiments of the present invention could replace the specific decomposition, components and inner relationships of an AP Hub with other equivalent or similar configurations. Most pertinent here and explained below are the functions performed by the coordination service 20, constraint manager 21, auditing service 25 and process store 28, as well as the user functions they enable. Note that constraint management is a well known function in the field of artificial management, but not for business process management.

All information about process specifications, process instances, and process objects such as activities, participants and application-specific concepts is maintained in a process store 28. In one embodiment, the process store is one or more databases (e.g. relational or XML type databases) whose data is reliably maintained in some form of computer non-volatile memory. However, it is noted that here the process store denotes the full collection of said data elements such that they are accessible by the coordination service 20 when needed.

An embodiment deployed for use includes a process specification, maintained by the process store 28, for the business processes to be managed and integration software, registered with resource service 26, to the specific resources that will be needed. A process instance begins with a request to the coordination service 20 to create a new AP instance from a named activity definition found within process store 28. Upon receiving the request, coordination service 20 creates a set of data to represent the AP instance, which is then also maintained by the process store 28. This data includes the initial set of process activities, including their state and resolved roles, the initial set of process participants, and a network of constraints between data elements. Constraint manager 21 maintains the network of constraints and propagates implied changes in response to new inputs. When a participant role is resolved to a resource, the corresponding activity is assigned to that resource via the resource service 26. When a participant role is resolved to a user, the corresponding activity is assigned to that user via the appropriate application-specific and user-preferred means, such as conventional email, work queue dashboard, or pager notification. Users interacting with the system, resources completing assigned activities, and time progressing can all affect data values and activate events defined by the process guidelines. Each value change or event activation is reported to the constraint manager 21, which updates its constraint network. The coordination service 20 inspects these changes to assign new activities, update existing activities, or perform other needed operations in support of the process instance. The AP instance is complete when all activities have been completed and no new activities are required.

Adaptive Process Definition and Dynamic Assembly

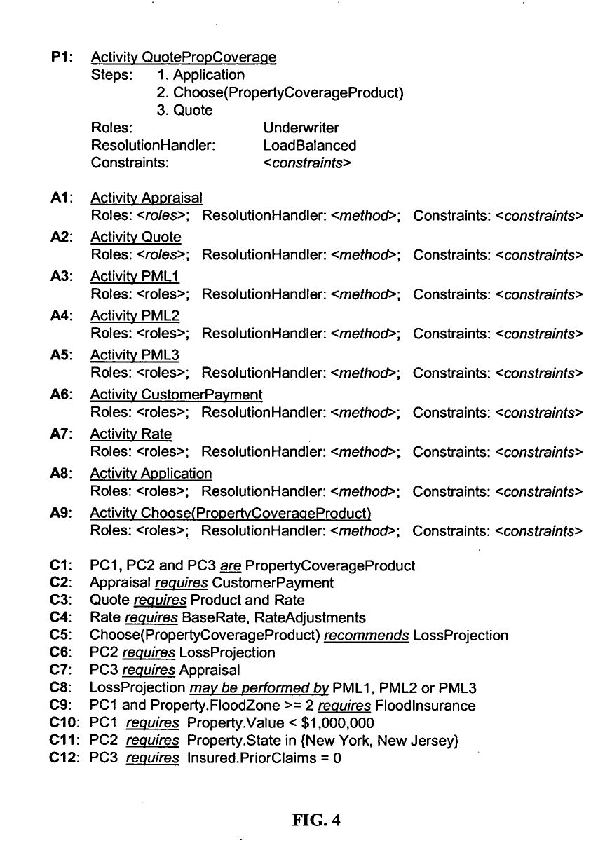

FIG. 4 shows an exemplary process specification for the business process of obtaining a commercial insurance property coverage policy quote. It defines all relevant activities and constraints or general guidelines, all presented in a stylized English language format. While the English language format simplifies for presentation the syntactic details found in most expected embodiments, significant simplification is also achieved by the elimination of the prior art state machine representation. Processes are any potential sequence of activities within stated business constraints and, in one embodiment, activity definitions only state their most elemental objectives. At the time they are developed, there may be numerous known and unknown ways to achieve their objectives and numerous known and unknown relationships between them. For example, activity definition P1 in FIG. 4 defines the QuotePropCoverage activity, which here has been further distinguished as an activity that can be used to create a new AP instance. It states that the process for obtaining a commercial insurance policy quote includes the completion of an insurance application, followed by choosing a property coverage insurance product, followed by the creation of the quote. These three steps reduce the process to its most basic elements. The act of selecting a product may impose additional requirements, such as shown in constraint C5, which recommends a LossProjection activity.

Activity definitions A1-9 declare the Appraisal, Quote, PML1, PML2, PML3, CustomerPayment, Rate, Application and Choose (PropertyCoverageProduct) activities, respectively. PML means probable maximum loss in insurance parlance. The presence of role specifications, an identified resolution handler, and the zero or more constraints imposed by each activity A1 to A9 are indicated, but not shown here in further detail. For example, PML1 may be constrained to insurance for properties in Florida and South Carolina, and may only analyze hurricane exposures. In addition, nine constraints are defined (C1-9) to complete the overall example. Constraint C1 declares that there are three property coverage insurance policy products, namely PC1, PC2 and PC3. In one embodiment, the set of available insurance products would normally be retrieved from a more extensive database and the contents of constraint C1 completed at software runtime so that it is relatively simple to change the insurance product set, or the product set would be determined once all of the individual product specifications have been retrieved.

Constraints C2, C3, C4 and C5 each define relationships between activities. Constraint C2 states that before the Appraisal activity can be performed, the CustomerPayment activity must be completed. Constraints C3 and C4 define similar relationships. Constraint C5 states that a LossProject activity is recommended if a PropertyCoverageProduct is being chosen.

Constraints C6, C7 and C9-12 each define relationships between data values and activities. Constraint C6 states that if the selected insurance product is PC2 then the LossProjection activity must be performed. Similarly, constraint C7 states that if the selected insurance product is PC3 then the Appraisal activity must be performed.

Finally, constraint C8 defines a relationship between an abstract activity, LossProjection, and specific activity definitions that could be used to achieve LossProjection, namely PML1, PML2 or PML3.

In various embodiments of the process management system, driven in part by the differing needs of industry-specific applications, a wide variety of constraint relationships between activities, between activities and data, and between data are possible. Examples include one or more activities requiring, recommending or blocking one or more other activities; activities serving as potential alternative ways to perform other activities; temporal ordering relationships between activities; and set relationships between different activity or data value options. The present system uses the representation and processing of constraints, with numerous semantic relationships implied by the constraints possible.

An advantage of embodiments of the present system is that actions and data are defined in a common representation and are treated uniformly by constraint manager 21. The constraints which define a business, such as the business' products and process guidelines, are defined and maintained in a single representation that can be used for multiple purposes, including process management, decision support, and data consistency enforcement. How the actual constraints are calculated would be clear to one skilled in the art.

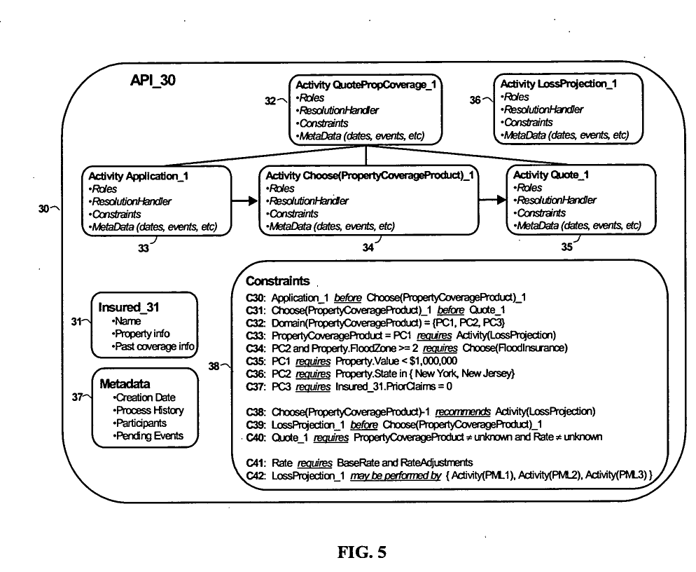

AP instances are constructed dynamically during the course of a process instance in response to new information, including user decisions, data modifications, temporal events, and activity status changes. To take an example from the insurance policy quotation process specification of FIG. 4, consider a case in which a request is made to create a new AP instance from activity definition P1, QuotePropCoverage, for insurance applicant Insured_31 (see FIG. 5). Coordination Service 20 retrieves the definition P1 from Process Store 28 and creates data structures within a section of computer memory to represent the new AP instance. FIG. 5 shows an example of the new AP instance 30, which the Coordination Service 20 has called “API_30”. It includes data structures for Insured 31 and the activity created from the requested activity definition P1, shown as Activity 32 QuotePropCoverage_1. As a result of Activity 32, it further creates Activities 33, 34, and 35 corresponding to the three constituent steps defined by P1. AP instance 30 also includes data about itself, Metadata 37, which is an extensible set of data such as its creation date, the process history maintained by auditing service 25, the current set of participants, and any pending events such as reminders and due dates.

Coordination Service 20 also creates within Constraint Manager 21 a network of constraints 38 that is unique to AP instance 30 and is derived from the process specification of FIG. 4. The software algorithm driving the creation, structure and processing of constraint network 38, and in turn AP instance 30, can be varied to account for requirements tradeoffs in processing time and memory space usage. For applications where response time must be fast and memory use limited, some embodiments can delay the creation of constraints, variables and activities until they are needed. Delaying these constraints and their implied activities can simplify the constraint satisfaction task performed by Constraint Manager 21 considerably, even to the extent of being the difference between a practical or impractical embodiment. However, it can come at the cost of incompleteness, creating the possibility that some implications or inconsistencies may be missed at points in the process. For the current example, a “complete” software algorithm is used, which continues to create and satisfy constraints until no further progress can be made without a participant or temporal dependency. Variant pertinent software algorithms are described below.

Constraints C30-37 are formed directly from the creation of Activity 32, its constituent activities 33-35, and Insured 31. Constraint C32 causes the creation of the variable “PropertyCoverageProducf”, whose possible values are PC1, PC2 and PC3. Initially, the value of PropertyCoverageProduct is unknown. Constraint C38 is subsequently formed from constraint definition C5 as a result of the creation of Activity 34, while Constraint 40 is formed from constraint definition C3 as a result of the creation of Activity 35. Activity 36 is created and labeled “recommended” in response to Constraint C38, which recommends a LossProjection activity if a PropertyCoverageProduct is being chosen. The creation of Activity 36 then causes the creation of Constraints C39 and C42. Constraint C41 is similarly created dynamically as a consequence of creating the activities and constraints upon which it depends.

At this point, no further constraint processing is possible and pending activities are assigned. Activity 33 (Application_1) is required and has no pending preconditions. Its role is resolved to a resource that processes the information within Insured 31's application. That resource is invoked and the results are entered into the data maintained for Insured 31. In this example, it includes data stating that Insured_31 has no prior claims, and that the property to be covered is located in California and worth $5 million. Further constraint processing occurs in response to this new information. Constraint C35 eliminates PC1 as a possible value for PropertyCoverageProduct. Constraint C36 eliminates PC2 as a possible value for PropertyCoverageProduct. Given that it does not equal PC1 or PC2, Constraint C32 forces PropertyCoverageProduct=PC3. For this application, it has been decided that recommended activities will be dismissed if all activities causing the recommendation can be completed by the system without user intervention. Alternate choices, described below, show how the system supports automatic, context-sensitive decision support. Because of this choice, Activity 34 is declared complete, with the selection being PC3. Completion of Activity 34 causes Activity 35 to begin, whose role is resolved to a resource that calculates the value of Rate, BaseRate and RateAdjustments. That resource is invoked, the values for Rate, BaseRate and RateAdjustments are set, and Constraints C40 and C41 are satisfied. The quote is returned, all constraints are satisfied, and all pending activities are completed. AP instance 30 is complete and processing stops.

An advantage illustrated in this example is that the specific process decisions and path are constructed dynamically in response to the information (data) unique to Insured 31 and the decisions and data acquired during the process. It creates an optimal response that is a function of this example's unique characteristics, without the need for an a-priori state machine process specification that must anticipate all possible process decisions and paths. The present inventor has recognized that anticipating all possible conditions, paths and decisions that may occur during the course of business is impossible in practice for business processes that have a large number of options or require the skilled judgment of experienced individuals.

Managing Options

For many business processes, a primary task is to identify potential options and decide which options to select or investigate further. Examples of options that can occur include alternate products, alternate terms, alternate service providers, alternate assessments of a customer's profile, and alternate process paths and activities. Neither known process management systems nor rule-based decision support systems are technically capable of representing options, and thereby are also incapable of assisting in the assessment and selection of options.

There are several known standard methods for working around this limitation. Most common is to design the system to record answers provided by users, such as the form-entry style of interaction typical in most enterprise software applications. Selection between options is left to the user and is usually limited to options between possible data values. Another common approach is to require that all options and conditions for selecting among them be identified at development time so that all possible process paths implied by these options can be explicitly coded. This effectively eliminates the options and replaces them with predetermined branches in the process path. However, this can only work to the extent that all options and conditions are accurately anticipated at development time and no user judgment is required, which is rarely the case. In all of these approaches, the user is unassisted in the option identification and selection effort, the interactions between decisions and process implications cannot be explored, and the corresponding decision process cannot be recorded for future analysis.

An aspect of the present system is that the constraint system and the process management software algorithms utilizing those constraints are based on the representation and management of options (“Algorithm” here refers to a set of computer enabled steps). Processes are not predetermined but rather are a sequence of decisions among the relevant options. This technique provides more powerful and easier to maintain process management capabilities, even in situations where full automation is achieved and user participation is not required. A situation like this is shown above for the example illustrated in FIG. 5, in which the system dynamically composed the optimal process and selected PC3 among the set of product options.

In situations where user participation occurs, exposing the options and their dependencies to the user provides more powerful, context sensitive decision support capabilities, uniquely achieved from the same process representation. Returning to the example of FIG. 5, assume instead that Insured 31 has no prior claims and that the property to be insured is located in New York, is worth $5 million, and is in a level 2 flood zone. When all constraints have been satisfied and Activity 34 is reached, there are three insurance product options: PC1, PC2, and PC3. PC1 is eliminated from consideration automatically by the system given the fact that the property is worth $5 million. However, PC2 and PC3 are both consistent and therefore allowed options. These two are presented to the user who was assigned Activity 34, along with their dependencies and implications. For some applications, it may also be desirable to present the user with option PC1 along with the reason or reasons why it was eliminated. Given the options, the user can inspect that PC2 is allowed because the property is located in New York and can also inspect that PC3 is allowed because Insured 31 has no prior claims. The user can also inspect the consequences of each option as part of the decision making process, sometimes known as a “what if” analysis. For example, the user can temporarily choose PC2 to discover that selecting the PC2 product will require Insured 31 to also purchase flood insurance due to constraint C34. The user may wish to ask Insured 31 if that is a desirable option, or the user may decide that PC3 is the more attractive option under these conditions. Similar decision support capabilities are illustrated by Constraint C38, which recommends but leaves for the user the decision to perform a Loss Projection, and Constraint 42, which presents the user with a set of options for how to complete the Loss Projection. As with the selection of PropertyCoverageProduct, the selection of Loss Projection options could be further supported by additional constraints that give limitations and preferences between the PML1, PML2 and PML3 activities.

An advantage is that activity options, data options, the constraints between them, and the dependencies behind existing assumptions and decisions may be all managed together in a common representation. As a result, sophisticated decision support across all options and interdependencies is made possible and without need for multiple representations and algorithms. A further advantage is that ambiguity caused by insufficient process instance information or an incomplete process specification is automatically handled as part of the intended design. Ambiguities result in a user task to decide between the set of available options, which as described following may include options not known to the process management system.

Making Exceptions Part of the Process

A long standing challenge for process management systems is that the actual business process instance may encounter conditions that are inconsistent with the process specification as formulated at development time. These situations are commonly referred to as “exceptions”. When an exception condition occurs, known process management systems are unable to continue. In more advanced systems, a designated user is assigned the task of resolving the situation by changing the conditions that led to the exception, thereby forcing the process instance to conform to the process specification.

In most business settings, particularly those that require skilled judgment, unexpected conditions and deviations from defined guidelines occur frequently. Determining the possible options and how to respond is part of the decision making effort that must occur. An advantage of the present invention is that exceptions to guidelines defined by the process specification are explicitly identified and represented by Constraint Manager 21. As a result, exceptions become options for decision making and as such are as available for inspection and what-if analysis as all other options.

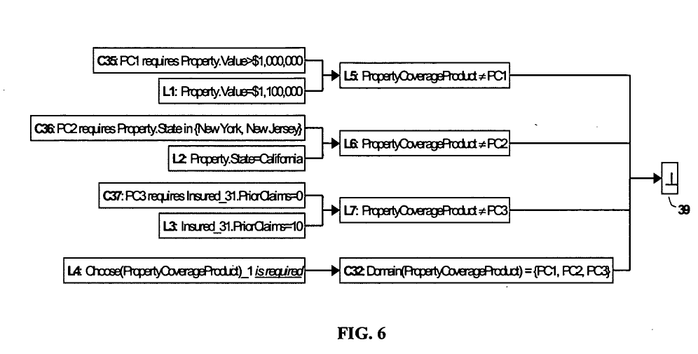

Returning to the example of FIG. 5, assume instead that Insured 31 has ten prior claims and that the property to be insured is located in California and worth $1.1 million. When all constraints are satisfied and Activity 34 is reached, all three product options (PC1, PC2 and PC3) are eliminated due to constraints C35-37. This condition violates constraint C32 when coupled with the requirement to complete Activity 34, putting Constraint Manager 21 into an inconsistent state. The relevant portion of the constraint network created by Constraint Manager 21 as data in computer memory and maintained by process store 28 is illustrated in FIG. 6. It shows the combination of data values and constraints resulting in contradiction 39, and thus the set of data and constraints that are in conflict. Analysis of these conflicts provides the basis for a new decision task.

According to the present system, there are at least two methods for responding to an inconsistent state. Using the first method, the violation is presented to the user for resolution as a set of options. These options include changing the contradictory data values as well as overriding the violated constraints. Importantly, exceptions to stated guidelines are explicitly represented, analyzed, decided, and recorded. In the situation presented in FIG. 6, the user has the option to make a guideline exception for PC1, PC2 or PC3 by overriding constraint C35, C36 or C37, respectively; make a guideline exception to required Activities 34 and 35 by rejecting the application and overriding asserted Literal L4; or reassessing the property value to $1,000,000 and changing Literal L1. These options are fully inspectable for analysis using the same methods described above. For example, the user can see that PC1 was eliminated because the property value is $1.1 million (Literal L1), which is 10% over the required maximum. Assume the user decides to override constraint C35 and select product PC1. When this occurs, Constraint Manager 21 suspends Constraint C35, causing it to be temporarily removed from constraint network 38. With the removal of Constraint C35, Literal L5 is unknown, PC1 is a consistent option, Constraint C32 is no longer violated, Constraint 32 forces PropertyCoverageProduct=PC1, and the process continues from there with the decision to override Constraint C35 recorded by auditing service 25. This method is further enhanced by the use of security authorization techniques to control the user's ability to override individual constraints. For example, if Constraint C35 has important regulatory implications, the process specification could state that the right to override Constraint C35 is limited to the Chief Underwriting Officer of the insurance company.

In one embodiment, the constraint network shown in FIG. 6 may be presented to the user in an easily understood natural language and/or graphical format that can be further inspected for increasing detail. An example would be “No product is available for this customer”, followed by “The customer is not eligible for PC1 because the property is valued at $1,100,000 while the maximum allowed property value for PC1 is $1,000,000.”

Using the second method, general-purpose and/or domain-specific contradiction handling software algorithms are provided to establish prescribed guidelines for when, how and in what preferred order violated constraints may be suspended, thus enabling the system to automatically resolve the conflict without user intervention. For example, an additional constraint could declare that exceptions within 10% of the required value may be approved, perhaps with the additional condition that the exception approval must be presented to a manager for confirmation.

By explicitly identifying and representing exceptions, which occurs naturally in the present system invention as constraint violations managed by Constraint Manager 21, exceptions become standard elements of AP instances and are treated uniformly. Business process instances are not required to conform to predefined process specifications and the decision making effort required to address exceptions is directly supported and recorded by the system.

Adapting To New Options

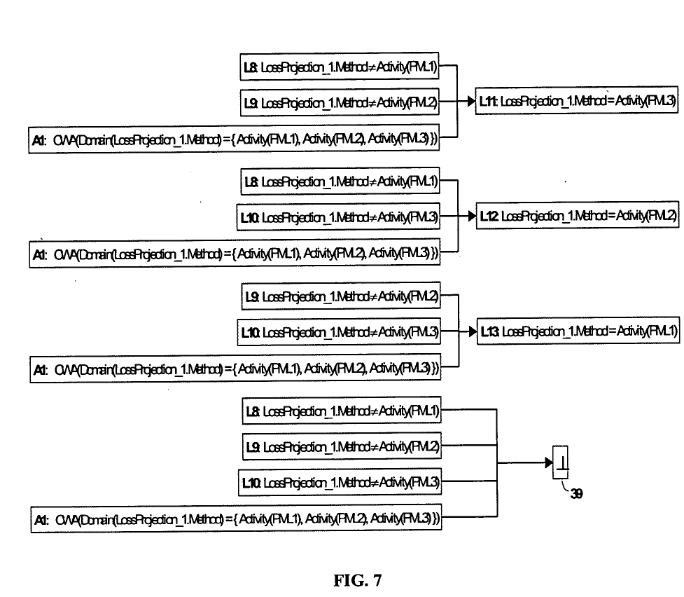

With the methods described above, options are optimally derived dynamically for each unique context. The terms “Optimal” and “optimizing” here mean making a process schedule or sequence more ideal, i.e. closer to an optimal condition, and one not limited to systems which yield provably optimal processes under given conditions. However, the set of all possible options is still limited to those variables, terms and constraints defined in the process specification. Another long standing challenge for process management systems is that actual business process instances may encounter unanticipated conditions or may require unanticipated activities. According to the present invention, adaptation to these situations is naturally managed through the use of “closed world assumptions” (CWA). A CWA states explicitly the assumption that all known options are the only possible options. For example, the CWA implicit in Constraint C42 is that PML1, PML2 and PML3 are the only possible ways to perform a Loss Projection. FIG. 7 illustrates this portion of Constraint Network 38, reformulated to include explicit CWA A1 for the known ways to perform a Loss Projection. It shows, for example, that forcing the selection of PML3 (L11) because PML1 and PML2 are ruled out is dependent upon CWA A1. If CWA A1 is not assumed, PML3 is not a required choice. Further, if CWA A1 is not assumed, new choices that were not defined in the process specification become possible and may be added dynamically at runtime without requiring reformulation of the process specification. For example, if CWA A1 is replaced by an updated closed world assumption that includes a fourth PML activity, the conclusions drawn by Constraint Manager 21 are automatically updated to reflect the existence of four Loss Projection methods.

By making CWAs explicit, the present system is able to make explicit the possibility of unanticipated activities or conditions and thereby uniformly apply the full power of the system's process management, decision support and auditing capabilities to unanticipated and hence uncoded situations. The reality that everything cannot be anticipated in full at the business process development time is assumed. This capability is further enhanced by the use of security authorization techniques to control the user's ability to modify CWAs and thus adapt the process specification at runtime. While it may be desirable to allow new ways to perform Loss Projection, it may also be desirable to require that this ability be limited to specific individuals (users).

Returning to the example of FIG. 5, assume instead that Insured 31 has no prior claims and that the property to be insured is located in New York and worth $600,000. Assume further that when Activity 34 is reached the user selects product PC1. Due to Constraint C33, a Loss Projection must be performed. Due to Constraint C42, the options PML1, PML2 and PML3 are presented to the user. At this point, the user examines each of the options, along with other available data, and concludes that the best course of action is none of these options but rather to use a custom technique offered by a regional consulting firm. Using the CWA method of representing Constraint C42 that is illustrated in FIG. 7, this decision is properly handled as an extension to CWA A1 rather than as an exception to guidelines. Further, it naturally triggers the runtime formation of a previously unknown new activity.

Two methods are defined for formulating new activities at runtime. In the first method, a “generic activity” is created automatically by Coordination Service 20. In the present example, it would be added to the set of possible Loss Projection methods as an updated version of CWA A1 and presented to the user, who will complete the activity and associated content. A generic activity has the elements common to all activities, such as a creation date and an assigned participant, but has no content beyond text entered by the user. In some embodiments, different affordances may be used to give the appearance of email or general “work assignment”. The first method is preferred if the new activity and updated CWA will be kept unique to the current AP instance and not used to update the process specification for future use. New activities that are effectively ad hoc requests for information are a good example of this situation.

In the second method, a “create new activity” software enabled dialog is presented to the user via his computer which gathers from the user all information needed to complete a full activity definition for the new activity. This dialog may lead the user through a set of questions or present a form to complete. It requests the user to document and specify in detail the activity's attributes, including name, roles, timing, constraints and other dependencies. In this manner, the system provides the capability to update the process specification maintained by Process Store 28 at runtime in response to new business conditions, rather than having to wait for the next round of development. The second method is preferred if the new activity and updated CWA are generally useful and worth maintaining for future use in the form of an updated process specification. The current example of identifying and using a new Loss Projection service is a good example of this situation. A variant of this method that may be preferred for some embodiments is to record the new activity definition and then assign it to a manager or business analyst for approval before updating the process specification.

A variant of these two methods is used to provide the user the capability to create a new generic activity in an ad hoc manner whenever the user deems necessary, even though a relevant set of options has not be identified. For example, while considering Insured 31's overall risk profile as part of Activity 34, the user may want to have the local zoning regulations examined. There is no mention of zoning regulations anywhere in the process specification and no relevant data element, constraint or CWA in constraint network 38. The user's request is accomplished in the present invention using one of the two methods for creating a new activity at runtime, followed by asserting the new facts about the activity to constraint manager 21. The present system's constraint-based techniques are incremental, allowing new assertions to be added to an AP instance at any time during the process, subject to authorization to do so. Further, there are no requirements that the constraints within an AP instance be a subset of the constraints defined in the process specification. Ad-hoc assertions can be made without concern that they might inappropriately alter the process specification.

While several methods employing the use of closed world assumptions have been presented here in the context of adapting to new activities, the same methods may be used to provide the capability to adapt to new data values or process paths. For example, many insurance underwriting processes include the task of classifying the applicant, which results in selection from a list of predefined categories. By representing these predefined categories as a closed world assumption, the present methods provide the capability to extend the set of categories if a novel applicant is encountered who cannot be classified into any of the existing categories.

Controlling the Timing of Actions and Events

All data elements and constraints between data elements in one embodiment are uninterrupted and treated uniformly by constraint manager 21. Manager 21 does not distinguish between a fact stating that Activity 34 must be performed and a fact stating that Property Value equals $1,000,000. To constraint manager 21, they are both facts whose possible values are TRUE, FALSE and UNKNOWN. When these facts are interpreted by coordination service 20, they result in different types of actions. An aspect of the present system is a set of methods to control when and how those actions should occur. For example, if an activity becomes required, then not required, then required again, the activity instance and any progress on that activity instance should be retained as appropriate for the business environment. It should not be recreated the second time it is deemed required, as if the original assignment did not exist and progress did not occur.

Control over the timing of actions is made available to the user or business process software developers as part of the process specification. The following are exemplary modifiers:

“Upon True” indicates that the action should occur every time the condition becomes true, at that moment it becomes true. “Upon False” indicates that the action should occur every time the condition becomes false. For example, this could be used to indicate that an alert should be sent every time a deadline becomes within one day away. If the deadline is changed after the first alert, a second alert would be sent if the new deadline were reached.

“Upon First True” indicates that the action should occur the first time the condition becomes true, at that moment it becomes true, but not again if the condition becomes false and then true again at a later time. “Upon First False” indicates that the action should occur the first time the condition becomes false.

“Upon Change From True” indicates that the action should occur every time the condition changes away from being true. This is not equivalent to “Upon False” because “Upon False” will apply if the AP instance begins with the condition being false, whereas “Upon Change From True” only applies if the condition was true immediately prior to this point in the process. “Upon Change From False” indicates that the action should occur every time the condition changes away from being false.

“Upon First Change From True” indicates that the action should occur the first time the condition changes away from being true. “Upon First Change From False” indicates that the action should occur the first time the condition changes away from being false.

“Whenever True” indicates that the action should continue as long as the condition is true. “Upon True” is best suited to situations where the initiation of action in response to some event is needed. “Whenever True” is best suited to situations where continuous effort, or lack thereof, is required, such as not performing some function as long as a dangerous condition is present. “Whenever False” indicates that the action should continue as long as the condition is false.

While these modifiers have proved useful in some embodiments many alternatives and variations to these modifiers, and to the timing conditions represented, are apparent to those skilled in the art.

Proposals and Commits to Control the Impact of What-if Analyses

When a user is performing a what-if analysis, consequences that have an impact outside the scope of the what-if analysis are normally undesirable. An example would be repeatedly notifying a user that a new activity has been assigned followed by notification that the activity assignment has been retracted, all because another user was investigating the effects of different options. Some undesired consequences can be quite damaging, such as a temporary what-if analysis causing an expensive activity with a permanent effect to be initiated.

According to the present system, these undesired consequences are prevented by employing constraint commit methods that are analogous to the known two-phase commit methods found in databases. During a what-if analysis, all changes are treated as a proposal. Their material impacts to process participants are not initiated until a commit is made against the current proposal. In this manner, the present system provides the capability to analyze the consequences of alternate decisions at length without unintentionally influencing the AP instance. Only once a decision is made and committed is the AP instance influenced.

Dynamic Constraint Algorithms

The software algorithms used by constraint manager 21 to drive the creation, structure and processing of a constraint network can be varied to account for requirements tradeoffs in processing time and memory space usage. Above, a “complete” algorithm is described, in which all possible constraint processing is performed at all times. This software algorithm has the advantage that all possible implications and inconsistencies are available to the process management system and its users at all times. It has the disadvantage that for some process specifications the time and computer memory required to complete that processing every time a change is made may be unacceptable. A second, related disadvantage is that some potential options may not be relevant to all AP instances. In these situations, forcing them to be represented and resolved is unnecessary and potentially inappropriate. The known theory of “dynamic constraint satisfaction” (See S. Mittal and B. Falkenhainer, “Dynamic Constraint Satisfaction Problem”, Proceedings of AAAI, Vol. 90, pp. 25-32, 1990 incorporated herein by reference in its entirety) was created for these situations. Some embodiments of the invention include methods for applying that theory to the problem of decision support and business process management.

Returning again to FIG. 5, where response time must be fast and memory use limited, one embodiment delays creation of Constraints C41 and C42, and the task to select between PML1, PML2 and PML3, until they are needed. For example, creation of Constraint C41 would be delayed until it was time to compute the Rate. Creation of Constraint C33 would be delayed until selection of the PC1 product was committed. In delaying Constraint C33, the creation of Activity 36 and Constraint C42 would also be delayed, thereby delaying the representation of and selection between options PML1, PML2 and PML3. Delaying these constraints and their implied activities can simplify the constraint satisfaction task performed by constraint manager 21 significantly.

Also provided in one embodiment via user interface 22 is a user's view of all assembled information relevant to the current process instance. This interface also assigns the set of required and recommended actions to the user for each insurance quote.

Information Requirements Process Example

The above description of an insurance related business process is only exemplary. Other examples from the insurance field include processes for, e.g., gathering required supporting documentation for actually issuing an insurance policy by listing the needed documents, tracking document status, and indicating when documents are overdue and the task is complete. Of course, the insurance field is also only exemplary of where the present system may be used.

Hence also contemplated is a system for determining and managing information requirements of a business process throughout the execution of the process, and supporting user decisions about the process's information requirements when the information may be presented in any format within the system and its source systems, including documents, structured relational data, distribute, semistructured collections, such as found on the world wide web. The management function tracks the status of each requirement throughout its entire life cycle, including initial establishment of requirement, deadlines and other temporal events concerning the requirement's fulfillment, assignment of activities to the required information, assignment of activities to review and make decisions based on the required information, and final fulfillment or failure to fulfill the requirements.

The system may also include a notification service that notifies one or more participants via the computer network or user interface the affordance of the requirement's change in status, including impending or past deadlines. The system may also include the ability to acquire the required information in multiple formats, including scanned documents, and assign activities to index information, review the quality of the information and the document image as appropriate, and transform the information to a format and structure more suitable to downstream processing.

Also contemplated is a system of this type applied to the process of mortgage loan origination when the system determines the supporting documentation requirements of a new mortgage loan request such as income statements, tax returns and appraisals, based on analysis of the mortgage loan borrower, the property and the requested loan product. The system dynamically modifies the supporting documentation requirements throughout the execution of a process in response to changes in the requested loan, the arrival of new information, and decisions made by the process participants and the system tracks the status of each requested document, including when it was requested, when it arrived, if it is overdue what actions must be performed, and all supporting documentation requirements have been satisfied.

A similar system may be applied to the process of life insurance new policy business origination and underwriting, wherein the system determines the underwriting requirements for the life insurance policy, such as blood tests, inspection, and attending physician statement based on an analysis of the proposed insured and the requested life insurance policy. This system dynamically modifies the requirements throughout the execution of the process in response to changes in requested policy, the arrival of new information, and decisions made by the process participants. The system tracks the status of each requirement, including when it was requested, when it arrived, if it is overdue what actions must be performed, and when all requirements have been satisfied.

Similar systems contemplated apply to the process of property and casualty insurance policy new business origination and underwriting wherein the system determines the policy underwriting requirements and analysis activities, such as loss projections, appraisals, and financial reports, based on analysis of the proposed insured and the requested policy. The system dynamically modifies the requirements and activities during the execution of the process in response to changes in the requested policy, the arrival of new information, and decisions made by the process participants. The system tracks the status of each requirement and activity, including when it was requested, when it arrived, if it is overdue what actions must be performed on it, and when all requirements have been satisfied.

Also contemplated is a similar system adapted to the process of financial services new account opening where the system determines the document requirements, such as bank balances, credit reports, investment objectives and risk tolerance, based on an analysis of the new account applicant and the requested type of account or investment product. The system dynamically modifies the document requirements throughout the execution of the process in response to changes in the requested account or investment product, the arrival of additional information, and decisions made by process participants. The system tracks the status of each requirement activity, including when it was requested, when it arrived, if it is overdue what actions must be performed, and when all the requirements have been satisfied.

Federated Operation

Some business processes may include participants in different organizations or companies or different locations around the world. In such cases, it can be impossible or undesirable to have every participant using the same process management system on the same physical computer network server. Reasons include computer network limitations, inter-organizational security policies, and different local definitions for the same activity class. As illustrated in FIG. 2, the present system may be configured with a plurality of process management systems. This capability is enabled by methods that maintain global consistency across the constraint networks managed within each participating process management system. Each process management system records with its copy of an AP instance a complete list of the process management systems currently participating in that AP instance. Whenever a change is committed by a participant to one process management system, that process management system then contacts all of the other participating systems and propagates the change to their coordination service through their service interface. A variant of this method that would be used in environments with poor network reliability is to have the different participating systems redundantly share the propagation task. For example, assume that systems A, B, C and D are participating in an AP instance. If the change originally occurs within system A, it would attempt to report the change to systems B and C. Systems B and C in turn would attempt to report the change to each other, and to system D. If system B is temporarily unable to contact system D, the probability of success is enhanced by system C, which may have a strong connection to system D. Directory services are used to record which systems are responsible for updating which other systems as a method to control the redundancy and reporting relationships.

Process Information Requirements

A central part of many business processes is the determination and fulfillment of information requirements that serve as input or validation for the decisions made within the process. Examples include mortgage loan origination and life insurance new business processing, in which the supporting information required to complete the process is identified early in the process and continually updated as new information is acquired.

In most business environments today, this information is contained in the form of paper and electronic documents. In the prior art, document management systems have been used to store the documents after they have been acquired. This includes the ability to scan paper documents and store them as images within the document management system. Such systems are passive in that they only react to the arrival of documents. They do not have the ability to determine what documents are required, issue requests to acquire the documents, determine when changes during the process affect document requirements, and proactively alert relevant systems or users if the documents are overdue or insufficient.

An aspect of the present system is that the constraint system and the process management method utilizing those constraints automatically determine and maintain the information requirements throughout the course of each process instance. The activity definitions define activities for gathering specific types of information as well as each activity's information preconditions and dependencies. As a process executes, information gathering activities are created and labeled “required” or “recommended” in response to constraints between those activities and other activities or data, such as an appraisal or loan product requirements. When data changes or activities are completed, their consequences are propagated through the constraints, which may cause additional activities to be labeled required or previously required activities to become no longer required.

Returning to the example of FIG. 5, assume that Insured 31 has requested property coverage product PC1. Constraint C33 determines that the activity to acquire a Loss Projection is required and therefore the policy cannot be issued until the requirement to acquire a Loss Projection has been satisfied. Assume further that during the process Insured 31 changes the requested product to be PC2. When this change has been fully propagated through the constraints, the Loss Projection requirement is removed. Loss Projection is still recommended due to constraint C38.

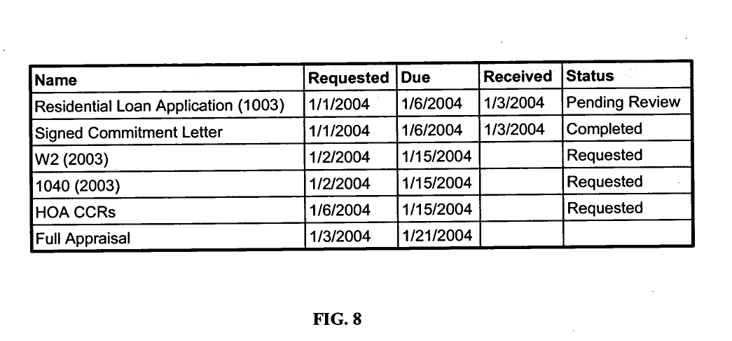

In one embodiment, the information requirements and their status information are presented to the user via the user interface in an easily understood format, such as a table or as a set of folders to mimic familiar document management presentation styles. As the required information is acquired, the presentation indicates the information's presence and enables the user to view the information in a suitable viewer, such as Microsoft's™ Internet Explorer™ or Word™. FIG. 8 shows a tabular example of such a presentation for an in-progress mortgage loan origination process. In this example, the system has identified six supporting documents that must be acquired before the loan can be closed and maintains that the 1003 and Commitment Letter documents have arrived, while the other four supporting documents have been requested but have not arrived. At the start of the process, on Jan. 1, 2004, the system determined that a 2003 W2 and a 2003 1040 were required from the borrower. Later, on Jan. 6, 2004, the system acquired the 1003 Loan Application and, based on the data contained therein, determined that a copy of the homeowner's association CCRs was additionally required.

Coding the software for a system as described here is well within the skill of one of ordinary skill in the art given this disclosure. A suitable computer language is e.g. Java, with a higher user language coded in XML.

While this invention has been described in conjunction with a specific system, many alternatives, modifications, and variations will be apparent to those skilled in the art in light of this disclosure. Accordingly, it is intended to embrace all such alternatives, modifications and variations as fall within the spirit and broad scope of the appended claims.

1. A system for managing a variable process operative with a computer communications network including at least one computer and one or more associated resources upon which the process operates the system comprising:
a process specification for storage in memory of at least one of the computers and to be interpreted as a set of constraints describing allowed, preferred and disallowed data values and process actions; and
a process management system for executing on at least one of the computers and using the stored process specification to maintain a state of the process.

2. A system according to claim 1, the process management system further supporting user decisions and comprising a user interface that provides analyses by altering data values and inspecting their implications with respect to the process specification.

3. A system according to claim 1, further comprising an audit trail for storage in the memory of at least one of the computers in the network and maintaining a history of data changes associated with the process management system.

4. A system according to claim 1 further comprising:
at least one additional process management system for executing on a plurality of computers in the network;
wherein each process management system includes a synchronization method that maintains a consistent state for each process instance for the plurality of process management systems.

5. A system according to claim 1, wherein the process specification has no requirement that the set of constraints describe all possible data values and process actions.

6. A system according to claim 1, wherein the state of the process management system includes user options and implications of actions and data values.

7. A system according to claim 3, wherein the audit trail includes actions and decisions of users.

8. A method to manage a variable process, comprising the acts of:
providing a data structure to represent an instance of the variable process and having a plurality of activities, a plurality of roles and participants, a plurality of variables and their possible data values, including variables whose domain is a set, and associated constraints;
recording requested changes in the variable process;
propagating through the constraints implications of the recorded changes according to relationships defined by the constraints;
optimizing selection and sequence of the activities according to supplied functions; and
executing the actions identified during the act of propagating.

9. The method of claim 8, further comprising the acts of:
providing a process specification defining a set of activity classes, roles, variables and data values, and constraints between them;
instantiating the process specification against data for an instance of the process, thereby creating the data structure to represent an instance of the process.

10. The method of claim 8, wherein a requested change is to suspend one or more constraints, wherein the suspension is recorded and the act of propagating removes the suspended constraints and associated implications from consideration in the data structure.

11. The method of claim 8, wherein the recording and propagating steps are performed on a copy of the data structure in response to a proposed change, and further comprising the acts of:
recording and propagating the changes on the data structure as requested.

12. The method of claim 8, the acts of recording and propagating further including accumulating a record of the changes made and storing the record as an audit trail.

13. The method of claim 12, wherein the acts of recording and propagating are in response to a proposed change, and further comprising the act of:
using the audit trail to undo previous acts in reverse order if the proposed is cancelled whereby the data structures are in the same state as before the proposed change.

14. The method of claim 8, further including the act of providing an interface by which a participant proposes data value changes and suspends constraints, and request information about consequences of the changes and suspended constraints.

15. The method of claim 8, the act of propagating further including:
detecting when a value is to be selected for a variable whose domain is a set and a plurality of consistent values exists for that variable;
creating an activity to choose a value for the variable;
resolving the activity's role to one or more users, and
assigning the activity to those users.

16. The method of claim 15, the activity assigning further including:
gathering for each consistent value conditions that make the value required and the conditions that eliminate the value;
presenting the conditions to the user; and
responding to proposed data value changes and proposed constraint suspensions.

17. The method of claim 15, the activity assigning further including:
recording a request by the user to create a new value outside of the variable's domain;
creating a new assumption to expand the variable's domain to include the new value; and
propagating through the constraints of the data structure implications of the expanded assumption on the variable's domain according to the relationships defined by the constraints.

18. The method of claim 17, further comprising checking the user's rights to change the variable's domain using rights authorization, and rejecting the change if the user is not authorized to make the change.

19. The method of claim 8, wherein the constraints are each mathematical or logical.

20. The method of claim 8, the act of propagating further including:
detecting when an inconsistency occurs in the data structure;
gathering conflicting data values or constraints determining the inconsistency; and
creating an activity to resolve the inconsistency.

21. The method of claim 20, the creating an activity including:
determining from a set of supplied contradiction handling routines which routines to invoke to resolve the inconsistency;
invoking the determined contradiction handling routines; and
recording and propagating changes requesting by the invoked contradiction handling routines, including data value changes and constraint suspensions.

22. The method of claim 20, the creating an activity including:
resolving the activity's role to one or more users and assigning the activity to those users;
presenting the conflicting data values and constraints to the user; and
responding to proposed data value changes and proposed constraint suspensions.

23. The method of claim 22, further comprising checking the user's rights to suspend the constraint using rights authorization, and rejecting the change if the user is not authorized to make the change.

24. The method of claim 22, the assigning the activity further including:
recording a request by the user to create a new activity as an option;
creating a new assumption, if an assumption exists, to expand the set of known activity options to also include the new activity; and
propagating through the constraints of the data structure implications of the expanded assumption on the set of activities according to the relationships defined by the constraints.

25. The method of claim 24, the new activity request recording further including:
creating a new activity instance from a base activity definition class;
resolving the role to the user who requested the new activity and assigning the activity to that user; and
handling future participant requests concerning the new activity using methods applied to other activities.

26. The method of claim 24, the new activity request recording further including:
presenting a dialog to the user to gather information concerning the desired new activity from the user, including name, roles, constraints and subactivities;
using the gathered information to create a new activity instance and recording that activity instance with the data structures;
propagating through the constraints of the data structure implications of the new activity according to the relationships defined by the constraints; and
if requested by the user, creating a new activity definition including the gathered information and adding that activity definition to the process specification.

27. The method of claim 24, further comprising checking the user's rights to add a new activity or change the set of activity options using rights authorization and rejecting the addition or change if the user is not authorized to make the change.

28. The method of claim 8, further comprising controlling timing and interpretation of actions using state transition modifiers.

29. The method of claim 8, wherein constraints, variables and choice sets are created in the data structure when required by the constraints within the context of the current set of data values.

30. A method for managing a variable process, comprising the acts of:
providing data relevant to an instance of the variable process;
providing a process specification for the variable process;
providing a plurality of constraints for the variable process;
deriving facts and assumptions from the instance of the variable process and the process specification; and
representing a state of the variable process and options for the variable process from the constraints and the derived facts and assumption.

31. A method for managing a variable process, comprising the acts of:
providing a plurality of constraints for the variable process;
providing a process specification the variable process;
determining a state of the variable process from the process specification and constraints; and
determining options pertinent to the determined state.

32. The method of claim 31, wherein the options each pertain to at least one past, present or further tasks, task ordering, and data values relevant to the state.

33. A computer readable storage medium storing computer code to carry out the acts of the method of claim 8.

34. A system for managing information requirements of a variable process, wherein:
the information is represented in a plurality of formats, including documents, structured relational data, and distributed, semi-structured collections, the system comprising:
a management function which tracks the status of each requirement, including initial establishment of the requirement, deadlines and events concerning the requirement's fulfillment, assignment of activities to gather the required information, assignment of activities to review and make decisions based on the required information, and final fulfillment or failure to fulfill the requirement.

35. A system according to claim 34, further comprising a notification service that notifies one or more participants of the requirement's change in status.

36. A system according to claim 34, wherein the system acquires the required information in multiple formats, and assigns activities to index the information, reviews the quality of the information and the image of documents as appropriate, and transforms the information to a format and structure for downstream processing.

37. A system according to claim 34, adapted to the process of property mortgage origination, wherein:
the system determines supporting documentation requirements of a loan request, based on analysis of the mortgage borrower, the property and the requested loan product;
the system modifies the supporting documentation requirements during the execution of the process in response to changes in the requested loan, the arrival of additional information, and decisions made by process participants; and
the system tracks the status of each requested document, including when requested, when arrived, if overdue what actions must be performed, and when all supporting documentation requirements have been satisfied.

38. A system according to claim 37, wherein the supporting documentation includes income statements, tax returns and appraisals.

39. A system according to claim 34, adapted to the process of life insurance policy origination, wherein:
the system determines policy requirements, based on analysis of the proposed insured and the requested policy;
the system modifies the requirements during the execution of the process in response to changes in the requested policy, the arrival of additional information, and decisions made by process participants;
the system tracks the status of each requirement, including when requested, when arrived, if overdue what actions on it have been performed, and when all requirements have been satisfied.

40. A system according to claim 39, wherein the requirements include blood tests, inspection, and physician's statement.

41. A system according to claim 34, adapted to the process of property and casualty insurance policy origination, wherein:
the system determines the policy requirements and analysis activities based on analysis of the proposed insured and the requested policy;
the system modifies the requirements and activities during the execution of the process in response to changes in the requested policy, the arrival of additional information, and decisions made by process participants;
the system tracks the status of each requirement and activity, including when requested, when arrived, if overdue what actions must be performed, and when all requirements have been satisfied.

42. A system according to claim 41, wherein the policy requirements and analysis activities include loss projections, appraisals, and financial reports.

43. A system according to claim 34, adapted to the process of financial services account opening, wherein:
the system determines document requirements, based on analysis of the account applicant and the requested type of account or investment product;
the system modifies the document requirements during the execution of the process in response to changes in the requested account or investment product, the arrival of additional information, and decisions made by process participants;
the system tracks the status of each requirement and activity, including when it was requested, when arrived, if overdue what actions on it have been performed, and when all requirements have been satisfied.

44. A system according to claim 43, wherein the document requirements include bank balances, credit reports, and investment objectives and risk tolerance.
